(19) United States
(12) Patent Application Publication
(10) Pub. No.: US 2008/0163285 A1
(43) Pub. Date: Jul. 3, 2008

(54) VIDEO RECEIVING SYSTEM, SUB-CONTRACT VIDEO RECEIVER, VIDEO RECEIVING METHOD, PROGRAM, AND RECORDING MEDIUM

(75) Inventors: Osamu Tanaka, Osaka (JP); Hiroyuki Watanabe, Osaka (JP); Toyoshi Yamada, Osaka (JP); Nobuhiko Arashin, Osaka (JP); Masahiko Nagoshi, Osaka (JP)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 11/965,233

(22) Filed: Dec. 27, 2007

(30) Foreign Application Priority Data
Dec. 28, 2006 (JP) 2006-356562

(51) Int. Cl. H04N 7/16

(52) U.S. Cl. 725/25

(57) ABSTRACT

A video receiving system has one main-contract video receiver and at least one sub-contract video receiver connected to the main-contract video receiver via a network.

The sub-contract video receiver has a) a video reception control unit which, when a video reception tuner unit receives a video signal, allows the video reception tuner unit to receive the video signal of a limited predetermined channel if a network connection detecting unit detects an unestablished connection with the main-contract video receiver; and b) a display signal output unit which outputs a display signal corresponding to the video signal received by the video reception tuner unit.

### BACKGROUND OF THE INVENTION

1. Field of the Invention

The present invention relates to a video receiving system, a sub-contract video receiver, a video receiving method, and the like each of which has a function of receiving broadcasting videos under a contract for a plurality of video receivers. For example, the present invention relates to a video receiving system, a sub contract video receiver, a video receiving method, and the like for receiving broadcast programs from cable television stations.

2. Related art of the Invention

Basically, for a cable television contract, one subscriber signs up for one video receiver. However, an increasing number of subscribers sign up for a plurality of video receivers in order to receive an increased number of channels resulting from an increased number of services provided by cable television providers or to view broadcasting videos in a plurality of rooms. In this case, the cable television provider rents out a desired number of video receivers to the subscriber.

The subscriber having signed up for a plurality of video receivers is charged for that number of video receivers and thus bears a heavy burden of the fee. In order to prevent the subscriber from feeling that the fee is relatively expensive, some cable television providers adopt a subscription scheme allowing the subscriber to easily install a plurality of video receivers by, for example, setting a contract system with a reduced fee for a second video receiver and subsequent video receivers.

When the cable television provider signs up for a plurality of video receivers to be installed in the subscriber's house to rent out the receivers to the subscriber, the plurality of video receivers ordinarily have the same structure.

According to a reception scheme used, broadcasting videos transmitted on a cable television line are protected by a CAS (conditional access system).

The video receiver is composed of a reception tuner unit which selects the frequency of the subscriber's desired broadcasting program from modulated broadcasting video signals on the cable television line to select the channel of the broadcasting program to output the corresponding broadcasting videos, a CAS decrypting unit which decrypts the broadcasting videos, and a video decoding unit which decodes the decrypted broadcasting videos.

However, when one of the video receivers of the same structure is brought to a neighbor next door who is a non-subscriber and connected to the neighbor's cable television line, broadcasting videos can be viewed in a house other than the subscriber's house. This will be described below in detail.

FIG. 6 is a diagram showing the configuration of connections in a conventional cable television receiving system. FIG. 6(A) shows a diagram showing the connection configuration in normal use.

A subscriber 101 has signed up for three video receivers; the subscriber 101 has signed up for rental of three contract video receivers 103, 104, and 105 of the same structure. On the other hand, an unsubscriber 102 who is a next-door neighbor of the subscriber 101 has not signed up for cable television reception but has a cable television line 107 from a cable television station 100 routed into the house of the unsubscriber 102 because the unsubscriber belongs to the same district as that of the subscriber.

The subscriber 101 pays an ordinary contract fee for the contract video receiver 103 as a first receiver and pays a contract fee more inexpensive than that for the contract video receiver 103, for each of the contract video receivers 104 and 105 because the receivers 104 and 105 are a second receiver and a third receiver.

On the other hand, the unsubscriber 102 has not signed up yet and thus has no contract video receiver. The unsubscriber 102 thus plugs an ordinary television receiver 106 into a television outlet connected to the cable television line 107. The television receiver 106 cannot descramble scrambled broadcasting videos. Accordingly, the unsubscriber 102 can view only unscrambled broadcasting videos.

FIG. 6(B) is a diagram showing the configuration of connections made if the unsubscriber unduly uses the television receiver at an unreasonably inexpensive fee.

The unsubscriber 102 brings the contract video receiver 105 possessed by the subscriber 101 into the house of the unsubscriber 102 and connects the contract video receiver 105 to the television outlet in the house of the unsubscriber 102. In this case, since the contract video receiver 105 can descramble scrambled broadcasting videos distributed via the cable television line 107, the unsubscriber 102 can view scrambled broadcasting videos.

As a principle, to view scrambled broadcasting videos, the unsubscriber 102 must make a due contract and pays an ordinary fee for a first video receiver. However, if the contract video receiver 105 of the subscriber 101 who has signed up for a plurality of video receivers is brought into the house of the unsubscriber 102 for connection as shown in FIG. 6(B), the unsubscriber 102 can view broadcasting videos at the more inexpensive fee for the second and subsequent video receivers. That is, the unsubscriber 102 views broadcasting videos at the unreasonably inexpensive fee set for the second and subsequent video receivers, though the cable television station 100 can otherwise have the unsubscriber 102 pay the contract fee for the first video receiver in order to allow the unsubscriber 102 to view scrambled broadcasting videos. This results in a loss equal to the difference between the two contract fees.

Thus, a system has been disclosed in which a main-contract video receiver and sub-contract video receivers are rented out to the subscriber who has signed up for a plurality of video receivers to prevent unauthorized copying of broadcasting programs and viewing on a video receiver other than an authorized one, thus preventing unauthorized viewing of broadcasting videos in a house other than the subscriber's house at the unreasonably inexpensive fee (see, for example, Japanese Patent Laid-Open No. 10-322676).

That is, FIG. 7 is a block diagram illustrating a method of limiting viewing on a sub-contract video receiver in an inter-terminal control system disclosed in Japanese Patent Laid-Open No. 10-322676.

FIG. 7 shows only a part related to the method of limiting viewing on the sub-contract video receiver. The figure does not show a broadcasting video tuner unit or a video decoding process unit in a main-contract video receiver 112. However, the main-contract video receiver 112 obviously has these functions and independently enables the viewing of videos of broadcasting programs received from the cable television station 110 even when no sub-contract video receiver 113 is connected.

In this case, one subscriber has signed up for two video receivers and possesses the video receivers. The main-contract video receiver 112 is a first video receiver. A sub-contract video receiver 113 is a second video receiver.

The cable television line 114 from the cable television station 110 is not connected to the sub-contract video receiver 113 but only to the main-contract video receiver 112. The sub-contract video receiver 113 is connected to the main-contract video receiver 112 via a cable 115.

A viewing key creating unit 120 of the main-contract video receiver 112 creates a viewing key on the basis of a program ID transmitted together with broadcasting program data from the cable television station 110 and a main-contract apparatus ID which is inherent in the main-contract video receiver 112 and which is held by a main-contract ID holding unit 121. The viewing key contains the main-contract apparatus ID, a sub-contract apparatus viewing permission ID, and a program ID. The viewing key is superimposed on broadcasting program data by a mixer 122. The resulting data is transmitted to the sub-contract video receiver 113 via the cable 115.

In the sub-contract video receiver 113, a viewability determining unit 132 compares the sub-contract apparatus viewing permission ID, contained in the viewing key removed by a broadcasting video tuner unit 130, with the sub-contract apparatus ID of the sub-contract video receiver 113, held by a sub-contract ID holding unit 133. If the IDs have a predetermined relationship, the sub-contract video receiver 113 determines that viewing is enabled and notifies a video decoding process unit 131 of the viewability.

Broadcasting program data distributed on the cable television line 114 is encrypted. If the viewability determining unit 132 determines that viewing is enabled, the descramble function of the video decoding process unit 131 becomes active to enable broadcasting videos to be viewed. If the viewability determining unit 132 determines that viewing is not enabled, the descramble function of the video decoding process unit 131 does not become active, preventing viewing broadcasting videos on the sub-contract video receiver 113.

Consequently, even when the sub-contract video receiver 113 is brought to the neighbor next door, who is the unsubscriber, and is connected directly to the cable television line 114, connected to the cable television station 110, since the sub-contract video receiver 113 is not connected to the main-contract video receiver 112, the viewing key cannot be acquired, preventing the viewing of broadcasting videos distributed through the cable television line 114. That is, the inter-terminal control system makes it possible to prevent the unauthorized viewing of broadcasting videos in a house other than the subscriber's at the unreasonably inexpensive fee.

However, with the method implemented by the conventional inter-terminal control system in FIG. 7 to limit the viewability, when the unsubscriber connects the sub-contract video receiver 113 to the television outlet in the unsubscriber's house in order to view broadcasting videos at the unreasonably inexpensive fee, it is conventionally impossible to perform a desirable operation of displaying only a warning video urging the unsubscriber to normally use the video receiver 113. That is, the inter-terminal control system shown in FIG. 7 only enables all the broadcasting programs to be viewed or only inhibits all the broadcasting programs from being viewed.

That is, with the method implemented by the conventional inter-terminal control system in FIG. 7 to limit the viewability, none of the broadcasting programs can be viewed on the sub-contract video receiver 113 unless the viewing key created by the main-contract video receiver 112 can be acquired, regardless of whether or not broadcasting videos are scrambled.

Consequently, in the case of an erroneous connection or an attempt to view broadcasting videos with an unauthorized connection, it is conventionally impossible to perform a desirable operation of having the subscriber/unsubscriber view a warning video or the like urging the subscriber/unsubscriber to normally use the video receiver.

In view of these conventional problems, an object of the present invention is to provide a video receiving system, a sub-contract video receiver, a video receiving method, and the like each of which makes it possible to limit viewing on an unauthorized video receiver and which allows only videos of a particular channel to be viewed when the viewing is limited.

### SUMMARY OF THE INVENTION

The 1^{st} aspect of the present invention is a video receiving system comprising one main-contract video receiver and at least one sub-contract video receiver connected to the main-contract video receiver via a network,

the sub-contract video receiver comprising:

a network connection detecting unit which detects a status of connection with the main-contract video receiver in the network;

a video reception tuner unit which receives a video signal;

a video reception control unit which, when the video reception tuner unit receives the video signal, allows the video reception tuner unit to receive the video signal of a limited predetermined channel if the network connection detecting unit detects an unestablished connection with the main-contract video receiver; and

a display signal output unit which outputs a display signal corresponding to the video signal received by the video reception tuner unit.

The 2^{nd} aspect of the present invention is the video receiving system according to the 1^{st} aspect of the present invention, wherein the main-contract video receiver comprises:

a first identification information holding unit which pre-holds unique first identification information; and

a first identification information transmitting unit which transmits the first identification information in response to a request for transmission of the first identification information received from the sub-contract video receiver via the network, and

the sub-contract video receiver comprises:

a second identification information holding unit which pre-holds unique second identification information having the same value as that of the first identification information;

an identification information requesting unit which, when the network connection detecting unit detects an established connection with the main-contract video receiver, transmits the request for transmission of the first identification information to the main-contract video receiver; and

an identification information receiving unit which receives the first identification information transmitted by the main-contract video receiver,

wherein even when the network connection detecting unit has detected the established connection with the main-contract video receiver, the video reception control unit allows the video reception tuner unit to receive the video signal of the limited predetermined channel if the first identification information received from the main-contract video receiver does not match the second identification information pre-held by the second identification information holding unit.

The 3^{rd} aspect of the present invention is the video receiving system according to the 1^{st} aspect of the present invention, wherein the main-contract video receiver comprises:

a first identification information holding unit which pre-holds unique first identification information; and

a determination information transmitting unit which transmits, to the sub-contract video receiver, determination information indicating whether or not the second identification information received from the sub-contract video receiver via the network matches the first identification information pre-held by the first identification information holding unit, and

the sub-contract video receiver comprises:

a second identification information holding unit which pre-holds unique second identification information having the same value as that of the first identification information;

a second identification information transmitting unit which, when the network connection detecting unit detects an established connection with the main-contract video receiver, transmits the second identification information to the main-contract video receiver; and

a determination information receiving unit which receives the determination information transmitted by the main-contract video receiver,

wherein even when the network connection detecting unit has detected the established connection with the main-contract video receiver, the video reception control unit allows the video reception tuner unit to receive the video signal of the limited predetermined channel if the determination information received from the main-contract video receiver indicates that the second identification information does not match the first identification information.

The 4^{th} aspect of the present invention is the video receiving system according to the 1^{st} aspect of the present invention, wherein the main-contract video receiver and the sub-contract video receiver have the same configuration, the main-contract video receiver has a function of the sub-contract video receiver, and the sub-contract video receiver has a function of the main-contract video receiver.

The 5^{th} aspect of the present invention is the video receiving system according to the 1^{st} aspect of the present invention, wherein the network utilizes wiring which is connected to the main-contract video receiver and the sub-contract video receiver to distribute the video signal.

The 6^{th} aspect of the present invention is a sub-contract video receiver connected to a main-contract video receiver via a network, comprising:

a network connection detecting unit which detects a status of connection with the main-contract video receiver in the network;

a video reception tuner unit which receives a video signal;

a video reception control unit which, when the video reception tuner unit receives the video signal, allows the video reception tuner unit to receive the video signal of a limited predetermined channel if the network connection detecting unit detects an unestablished connection with the main-contract video receiver; and

a display signal output unit which outputs a display signal corresponding to the video signal received by the video reception tuner unit.

The 7^{th} aspect of the present invention is the sub-contract video receiver according to the 6^{th} aspect of the present invention, further comprising:

a second identification information holding unit which pre-holds unique second identification information having the same value as that of the unique first identification information pre-held by the main-contract video receiver;

an identification information requesting unit which, when the network connection detecting unit detects an established connection with the main-contract video receiver, transmits a request for transmission of the first identification information to the main-contract video receiver; and

an identification information receiving unit which receives the first identification information transmitted by the main-contract video receiver, wherein even when the network connection detecting unit has detected the established connection with the main-contract video receiver, the video reception control unit allows the video reception tuner unit to receive the video signal of the limited predetermined channel if the first identification information received from the main-contract video receiver does not match the second identification information pre-held by the second identification information holding unit.

The 8^{th} aspect of the present invention is the sub-contract video receiver according to the 6^{th} aspect of the present invention, further comprising:

a second identification information holding unit which pre-holds unique second identification information having the same value as that of the unique first identification information pre-held by the main-contract video receiver;

a second identification information transmitting unit which, when the network connection detecting unit detects an established connection with the main-contract video receiver, transmits the second identification information to the main-contract video receiver; and

a determination information receiving unit which receives determination information transmitted by the main-contract video receiver as a result of determination of whether or not the received second identification information matches the pre-held first identification information,

wherein even when the network connection detecting unit has detected the established connection with the main-contract video receiver, the video reception control unit allows the video reception tuner unit to receive the video signal of the limited predetermined channel if the determination information indicates that the second identification information does not match the first identification information.

The 9^{th} aspect of the present invention is the sub-contract video receiver according to the 6^{th} aspect of the present invention, wherein the video signal received by the video reception tuner unit is encrypted, and

the video reception tuner unit has a video decoding unit which decodes the video signal into a video.

The 10^{th} aspect of the present invention is the sub-contract video receiver according to the 6^{th} aspect of the present invention, further comprising a power supply status detecting unit which detects an on/off status of a power supply for the sub-contract video receiver,

wherein the video reception control unit allows the power supply status detecting unit to detect the on status of the power supply when the video reception tuner unit receives the video signal, and allows the video reception tuner unit to receive the video signal of the limited predetermined channel if the network connection detecting unit detects the unestablished connection with the main-contract video receiver.

The 11^{th} aspect of the present invention is the sub-contract video receiver according to the 6^{th} aspect of the present invention, wherein a video displayed on the basis of the video signal of the limited predetermined channel is a warning video urging normal use.

The 12^{th} aspect of the present invention is a main-contract video receiver connected to a sub-contract video receiver via a network, the main-contract video receiver comprising:

a first identification information holding unit which pre-holds unique first identification information; and

a first identification information transmitting unit which transmits the first identification information in response to a request for transmission of the first identification information received from the sub-contract video receiver via the network,

the sub-contract video receiver comprising:

a network connection detecting unit which detects a status of connection with the main-contract video receiver in the network;

a video reception tuner unit which receives a video signal;

a video reception control unit which, when the video reception tuner unit receives the video signal, allows the video reception tuner unit to receive the video signal of a limited predetermined channel if the network connection detecting unit detects an unestablished connection with the main-contract video receiver;

a display signal output unit which outputs a display signal corresponding to the video signal received by the video reception tuner unit;

a second identification information holding unit which pre-holds unique second identification information having the same value as that of the first identification information;

an identification information requesting unit which, when the network connection detecting unit detects an established connection with the main-contract video receiver, transmits the request for transmission of the first identification information to the main-contract video receiver; and

an identification information receiving unit which receives the first identification information transmitted by the main-contract video receiver,

wherein even when the network connection detecting unit has detected the established connection with the main-contract video receiver, the video reception control unit of the sub-contract video receiver allows the video reception tuner unit to receive the video signal of the limited predetermined channel if the first identification information received from the main-contract video receiver does not match the second identification information pre-held by the second identification information holding unit.

The 13^{th} aspect of the present invention is a main-contract video receiver connected to a sub-contract video receiver via a network, the main-contract video receiver comprising:

a first identification information holding unit which pre-holds unique first identification information; and

a determination information transmitting unit which transmits, to the sub-contract video receiver, determination information indicating whether or not the second identification information received from the sub-contract video receiver via the network matches the first identification information pre-held by the first identification information holding unit,

the sub-contract video receiver comprising:

a network connection detecting unit which detects a status of connection with the main-contract video receiver in the network;

a video reception tuner unit which receives a video signal;

a video reception control unit which, when the video reception tuner unit receives the video signal, allows the video reception tuner unit to receive the video signal of a limited predetermined channel if the network connection detecting unit detects an unestablished connection with the main-contract video receiver;

a display signal output unit which outputs a display signal corresponding to the video signal received by the video reception tuner unit;

a second identification information holding unit which pre-holds unique second identification information having the same value as that of the first identification information;

a second identification information transmitting unit which, when the network connection detecting unit detects an established connection with the main-contract video receiver, transmits the second identification information to the main-contract video receiver; and

a determination information receiving unit which receives the determination information transmitted by the main-contract video receiver,

wherein even when the network connection detecting unit has detected the established connection with the main-contract video receiver, the video reception control unit of the sub-contract video receiver allows the video reception tuner unit to receive the video signal of the limited predetermined channel if the determination information received from the main-contract video receiver indicates that the second identification information does not match the first identification information.

The 14^{th} aspect of the present invention is a video receiving method utilizing one main-contract video receiver and at least one sub-contract video receiver which connects the main-contract video receiver to a network, the method comprising:

a network connection detecting step of allowing the sub-contract video receiver to check whether or not the sub-contract video receiver is connected to the main-contract video receiver via the network;

a sub-contract receiving step of, when the sub-contract video receiver receives the video signal, allowing the sub-contract video receiver to receive the video signal of a limited predetermined channel if the sub-contract video receiver has not been connected to the main-contract video receiver yet; and

a sub-contract output step of allowing the sub-contract video receiver to output a display signal corresponding to the video signal of the limited predetermined channel.

The 15^{th} aspect of the present invention is a program recorded in a computer readable recording medium, the program allowing a computer to act as the video reception control unit of the sub-contract video receiver according to the 6^{th} aspect of the present invention which allows the video reception tuner unit to receive a video signal of a limited predetermined channel if the network connection detecting unit detects an unestablished connection with the main-contract video receiver.

The 16^{th} aspect of the present invention is a program recorded in a computer readable recording medium, the program allowing a computer to act as the first identification information holding unit which pre-holds unique first identification information and as the first identification information transmitting unit which transmits the first identification information in response to a request for transmission of the first identification information received from the sub-contract video receiver via the network of the main-contract video receiver according to the 12^{th} aspect of the present invention.

The 17^{th} aspect of the present invention is a program recorded in a computer readable recording medium, the program allowing a computer to act as the first identification information holding unit which pre-holds unique first identification information and as the determination information transmitting unit which transmits, to the sub-contract video receiver, determination information indicating whether or not the second identification information received from the sub-contract video receiver via the network matches the first identification information pre-held by the first identification information holding unit of the main-contract video receiver according to the 13^{th} aspect of the present invention.

The 18^{th} aspect of the present invention is a program recorded in a computer readable recording medium, the program allowing a computer to act as the first identification information transmitting unit which transmits the first identification information in response to a request for transmission of the first identification information from the sub-contract video receiver, as the identification information requesting unit which, when the network connection detecting unit detects an established connection with the main-contract video receiver, transmits the request for transmission of the first identification information to the main-contract video receiver, and as the video reception control unit which even when the network connection detecting unit has detected the established connection with the main-contract video receiver, allows the video reception tuner unit to receive the video signal of the limited predetermined channel if the first identification information does not match the second identification information of the video receiving system according to the 2^{nd} aspect of the present invention.

The 19^{th} aspect of the present invention is a program recorded in a computer readable recording medium, the program allowing a computer to act as the determination information transmitting unit, and as the video reception control unit which, even when the network connection detecting unit has detected the established connection with the main-contract video receiver, allows the video reception tuner unit to receive the video signal of the limited predetermined channel if the determination information received from the main-contract video receiver indicates that the second identification information does not match the first identification information of the video receiving system according to the 3^{rd} aspect of the present invention.

The 20^{th} aspect of the present invention is a program storage device readable by machine tangibly embodying the program according to the 15^{th} aspect of the present invention.

The 21^{st} aspect of the present invention is a program storage device readable by machine tangibly embodying the program according to the 16^{th} aspect of the present invention.

The 22^{nd} aspect of the present invention is a program storage device readable by machine tangibly embodying the program according to the 17^{th} aspect of the present invention.

The 23^{rd} aspect of the present invention is a program storage device readable by machine tangibly embodying the program according to the 18^{th} aspect of the present invention.

The 24^{th} aspect of the present invention is a program storage device readable by machine tangibly embodying the program according to the 19^{th} aspect of the present invention.

The present invention can provide a video receiving system, a sub-contract video receiver, a video receiving method, and the like each of which makes it possible to limit viewing on an unauthorized video receiver and which allows only videos of a particular channel to be viewed when the viewing is limited.

### BRIEF DESCRIPTION OF THE DRAWINGS

FIG. 1 is a diagram showing the configuration of connections in a cable television receiving system in accordance with Embodiment 1 of the present invention;

FIG. 2 is a block diagram showing the connection between a main-contract video receiver and a sub-contract video receiver in a cable television receiving system in accordance with Embodiment 1 of the present invention;

FIG. 3 is a block diagram showing connections in the cable television receiving system in which video receivers of the same configuration are used as a main-contract video receiver and a sub-contract video receiver in accordance with Embodiment 1 of the present invention;

FIG. 4 is a block diagram showing the connection between a main-contract video receiver and a sub-contract video receiver in a cable television receiving system in accordance with Embodiment 2 of the present invention;

FIG. 5 is a block diagram showing the connection between a main-contract video receiver and a sub-contract video receiver in a cable television receiving system in accordance with Embodiment 3 of the present invention;

FIG. 6(A) is a diagram showing the configuration of connections in a conventional cable television receiving system in normal use, and FIG. 6(B) is a diagram showing the configuration of connections in the conventional cable television receiving system in which an unsubscriber unduly views broadcasting videos at an unreasonably inexpensive fee; and

FIG. 7 is a block diagram illustrating a method implemented by a conventional inter-terminal control system to limit viewing on a sub-contract video receiver.

### DESCRIPTION OF SYMBOLS

10 Cable television station
11 Subscriber
12, 17, 19, 40 Main-contract video receiver
13, 16, 18, 25, 41 Sub-contract video receiver
14 Cable television line
15 Home network
20, 32, 42 Local connection unit
21, 34, 43 Broadcasting video tuner unit
22, 35, 44 CAS decrypting unit
23, 36, 45 Video decoding process unit
24, 37, 46 Video display unit
26, 38, 53 Display data output unit
30, 47 Power supply switch unit
31, 48 Power supply detecting unit
33, 49 Main-contract connection detecting unit
50, 60 Main and sub connection identification information holding unit
51, 91 Main and sub connection identification information request receiving unit
52, 92 Main and sub connection identification information transmitting unit
55 Main and sub view receiver switch
61, 81 Main and sub connection identification information requesting unit
62, 82 Main and sub connection identification information receiving unit
63, 83 Main and sub connection identification information match detecting unit
84 Main and sub connection identification information match information transmitting unit
93 Main and sub connection identification information match detection information receiving unit

### PREFERRED EMBODIMENTS OF THE INVENTION

Embodiments of the present invention will be described below with reference to the drawings.

### Embodiment 1

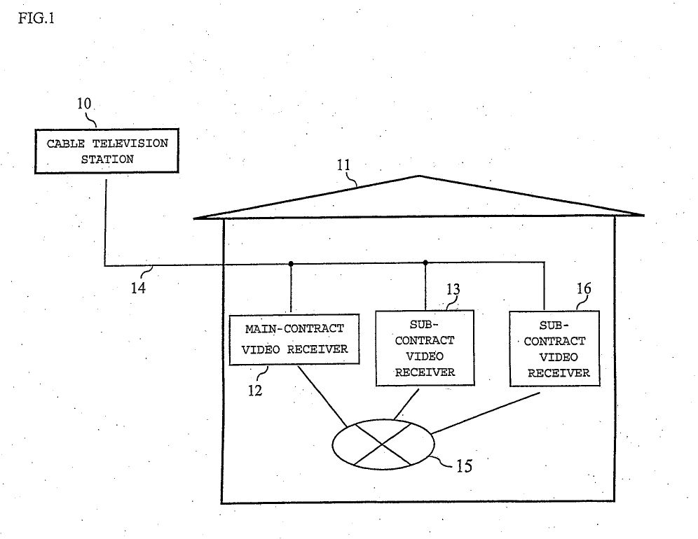

FIG. 1 is a diagram showing the configuration of connections in a cable television receiving system in accordance with Embodiment 1 of the present invention.

FIG. 1 shows a subscriber possessing three video receivers under a contract.

A cable television station 10 distributes videos to a subscriber 11 through a cable television line 14.

A main-contract video receiver 12, a sub-contract video receiver 13, and a sub-contract video receiver 16 are installed in the house of the subscriber 11 as a first video receiver to a third video receiver. The cable television line 14 is connected to each of the main-contract video receiver 12 and the sub-contract video receivers 13 and 16.

Each of the sub-contract video receivers 13 and 16 is connected to the main-contract video receiver 12 by a home network 15.

The home network 15 corresponds to an example of a network in accordance with the present invention. An example of a video receiving system in accordance with the present invention corresponds to a configuration including the main-contract video receiver 12, sub-contract video receivers 13 and 16, and home network 15 in the house of the subscriber 11 to the cable television receiving system in accordance with Embodiment 1.

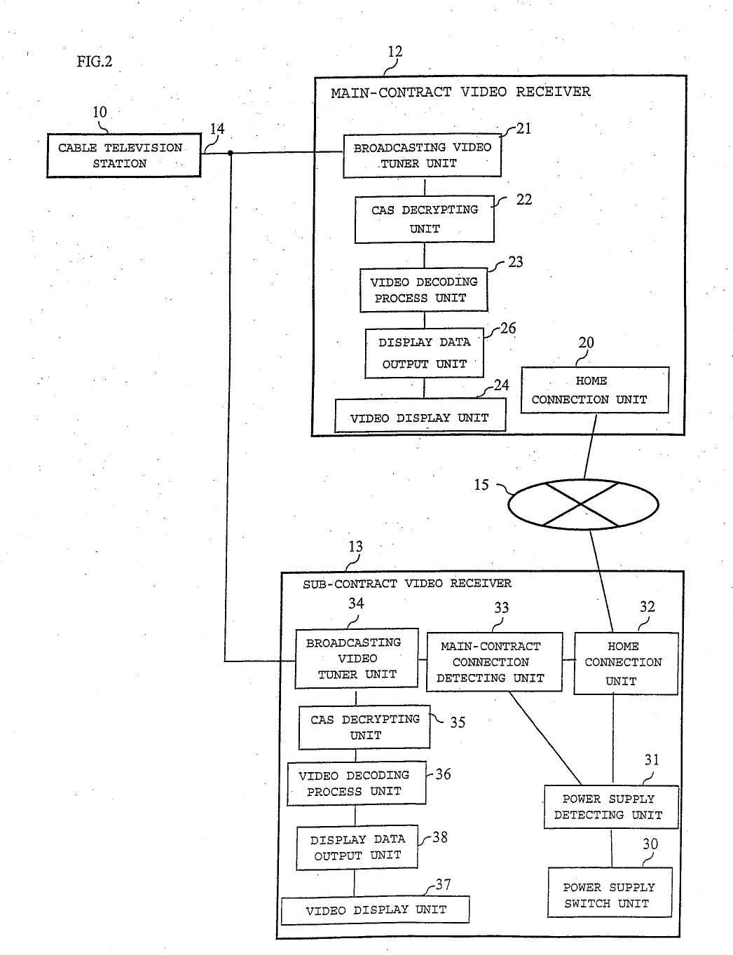

FIG. 2 is a block diagram showing the connection between the main-contract video receiver 12 and the sub-contract video receiver 13 in the cable television receiving system in accordance with Embodiment 1. The same components as those in FIG. 1 are denoted by the same reference numerals.

The configuration of the sub-contract video receiver 16 is the same as that of the sub-contract video receiver 13. FIG. 2 shows only the connection between the main-contract video receiver 12 and the sub-contract video receiver 13. The configuration of the connection between the main-contract video receiver 12 and the sub-contract video receiver 16 is similar to that of the connection shown in FIG. 2.

The main-contract video receiver 12 comprises a home connection unit 20 that connects the main-contract video receiver 12 to the sub-contract video receiver 13 via the home network 15.

The main-contract video receiver 12 also comprises a broadcasting video tuner unit 21, a CAS decrypting unit 22, a video decoding process unit 23, a display data output unit 26 and a video display unit 24.

The broadcasting video tuner unit 21 receives broadcasting videos distributed by the cable television station 10. The CAS decrypting unit 22 uses “key information” that is decryption information for CAS (conditional access system) to decrypt broadcasting videos of the channel selected by the broadcasting video tuner unit 21. The video decoding process unit 23 decodes the broadcasting videos decrypted by the CAS decrypting unit 22. Display data resulting from the decoding by the video decoding process unit 23 is then output by the display data output unit 26. The video display unit 24 then displays the videos.

The sub-contract video receiver 13 comprises a home connection unit 32 that connects the main-contract video receiver 12 to the sub-contract video receiver 13 via the home network 15.

The sub-contract video receiver 13 also comprises a power supply switch unit 30, a power supply detecting unit 31, and a main-contract connection detecting unit 33.

The power supply switch unit 30 turns on and off power to the sub-contract video receiver 13. The power supply detecting unit 31 detects an ON/OFF status of the power supply switch unit 30. The main-contract connection detecting unit 33 recognizes that the power supply detecting unit 31 has detected that the power is on and that the home connection unit 32 has checked whether or not the sub-contract video receiver 13 is connected to the main-contract video receiver 12.

The power supply detecting unit 31 corresponds to an example of a power supply status detecting unit in accordance with the present invention. The home connection unit 32 corresponds to an example of a network connection detecting unit in accordance with the present invention. The main-contract connection detecting unit 33 corresponds to an example of a video reception control unit in accordance with the present invention.

The sub-contract video receiver 13 comprises a broadcasting video tuner unit 34, a CAS decrypting unit 35, a video decoding process unit 36, a display data output unit 38, and a video display unit 37.

The broadcasting video tuner unit 34, CAS decrypting unit 35, video decoding process unit 36, display data output unit 38, and video display unit 37 have functions similar to the broadcasting video tuner unit 21, CAS decrypting unit 22, video decoding process unit 23, display data output unit 26, and video display unit 24 of the main-contract video receiver 12, respectively.

The broadcasting video tuner unit 34 corresponds to an example of a video reception tuner unit in accordance with the present invention. A configuration including a combination of the CAS decrypting unit 35 and the video decoding process unit 36 corresponds to an example of a video decoding unit in accordance with the present invention. The display data output unit 38 corresponds to an example of a display signal output unit in accordance with the present invention.

Now, description will be given of the operation of the cable receiving system in accordance with Embodiment 1 in which the main-contract video receiver 12 and the sub-contract video receiver 13 receive broadcasting videos from the cable television station 10. Further description will be given of an embodiment of a video receiving method in accordance with the present invention.

First, description will be given of the operation performed by the main-contract video receiver 12 to receive broadcasting videos.

The broadcasting video tuner unit 21 of the main-contract video receiver 12 receives, through the cable television line 14, broadcasting videos distributed by the cable television station 10 and selects a channel for viewing.

The CAS decrypting unit 22 uses “key information” that is decryption information for CAS (conditional access system) to decrypt broadcasting videos of the channel selected by the broadcasting video tuner unit 21. The video decoding process unit 23 then decodes the broadcasting videos decrypted by the CAS decrypting unit 22. Data resulting from the decoding by the video decoding process unit 23 is then output by the display data output unit 26 as display data. The video display unit 24 then displays the videos.

The main-contract video receiver 12 thus receives and displays the broadcasting videos distributed by the cable television station 10.

Now, description will be given of the operation performed by the sub-contract video receiver 13 to receive broadcasting videos. Separate description will be given of a case in which the sub-contract video receiver 13 is connected to the main-contract video receiver 12 by the home network 15 and a case in which the sub-contract video receiver 13 is not connected to the main-contract video receiver 12.

First, description will be given of the operation performed by the sub-contract video receiver 13 when the sub-contract video receiver 13 is connected to the main-contract video receiver 12 by the home network 15.

When the power supply switch unit 30 of the sub-contract video receiver 13 is turned on to receive videos, the power supply detecting unit 31 confirms that the power supply switch unit 30 has been turned on. When the power supply detecting unit 31 confirms that the power supply switch unit 30 has been turned on, the home connection unit 32 connects the sub-contract video receiver 13 to the main-contract video receiver 12 via the home network 15.

Upon recognizing that the power supply detecting unit 31 has confirmed that the power is on and that the home connection unit 32 has detected the connection between the sub-contract video receiver 13 and the main-contract video receiver 12, the main-contract connection detecting unit 33 notifies the broadcasting video tuner unit 34 that a “viewing through the contract channel is enabled”.

The broadcasting video tuner unit 34 receives broadcasting videos distributed by the cable television station 10 via the cable television line 14. In response to the notification from the main-contract connection detecting unit 33 that the “viewing through the contract channel is enabled”, the broadcasting video tuner unit 34 selects the channel through which all encrypted videos are viewed.

The CAS decrypting unit 35 uses “key information” that is decryption information for CAS (conditional access system) to decrypt data on broadcasting videos selected by the broadcasting video tuner unit 34. The video decoding process unit 36 then decodes the broadcasting videos decrypted by the CAS decrypting unit 35. Display data resulting from the decoding by the video decoding process unit 36 is then output by the display data output unit 38. The video display unit 37 then displays the videos.

Now, description will be given of the operation performed by the sub-contract video receiver 13 when the sub-contract video receiver 13 is not connected to the main-contract video receiver 12 by the home network 15.

When the power supply switch unit 30 of the sub-contract video receiver 13 is turned on to receive videos, the power supply detecting unit 31 confirms that the power supply switch unit 30 has been turned on. When the power supply detecting unit 31 confirms that the power supply switch unit 30 has been turned on, the home connection unit 32 attempts to connect the sub-contract video receiver 13 to the main-contract video receiver 12 via the home network 15. In this case, since the main-contract video receiver 12 is not connected to the sub-contract video receiver 13, the operation of the home connection unit 32 results in the detection of the sub-contract video receiver 13 not being connected to the main-contract video receiver 12.

Upon recognizing that the power supply detecting unit 31 has confirmed that the power is on and that the home connection unit 32 has confirmed that the sub-contract video receiver 13 is not connected to the main-contract video receiver 12, the main-contract connection detecting unit 33 notifies the broadcasting video tuner unit 34 that a “viewing through the contract channel is disabled”.

The broadcasting video tuner unit 34 receives broadcasting videos distributed by the cable television station 10 via the cable television line 14. In response to the notification from the main-contract connection detecting unit 33 that the “viewing through the contract channel is disabled”, the broadcasting video tuner unit 34 selects a fixed channel in order to allow only encrypted fixed videos to be viewed.

The CAS decrypting unit 35 uses “key information” that is decryption information for CAS (conditional access system) to decrypt the broadcasting videos of the fixed channel selected by the broadcasting video tuner unit 34. The video decoding process unit 36 then decodes the broadcasting videos of the fixed channel decrypted by the CAS decrypting unit 35. Display data resulting from the decoding by the video decoding process unit 36 is then output by the display data output unit 38. The video display unit 37 then displays the display data as fixed videos.

The term “fixed channel” as used herein refers to a channel that may be viewed without subscription. The term “fixed videos” as used herein refers to videos broadcast through the “fixed channel”. The “fixed channel” is, for example, such a channel as provided by a cable television provider. The “fixed videos” are such videos as show, for example, the message “connect to the main-contract video receiver”. A signal for the encrypted fixed videos corresponds to an example of a video signal of a limited predetermined channel in accordance with the present invention.

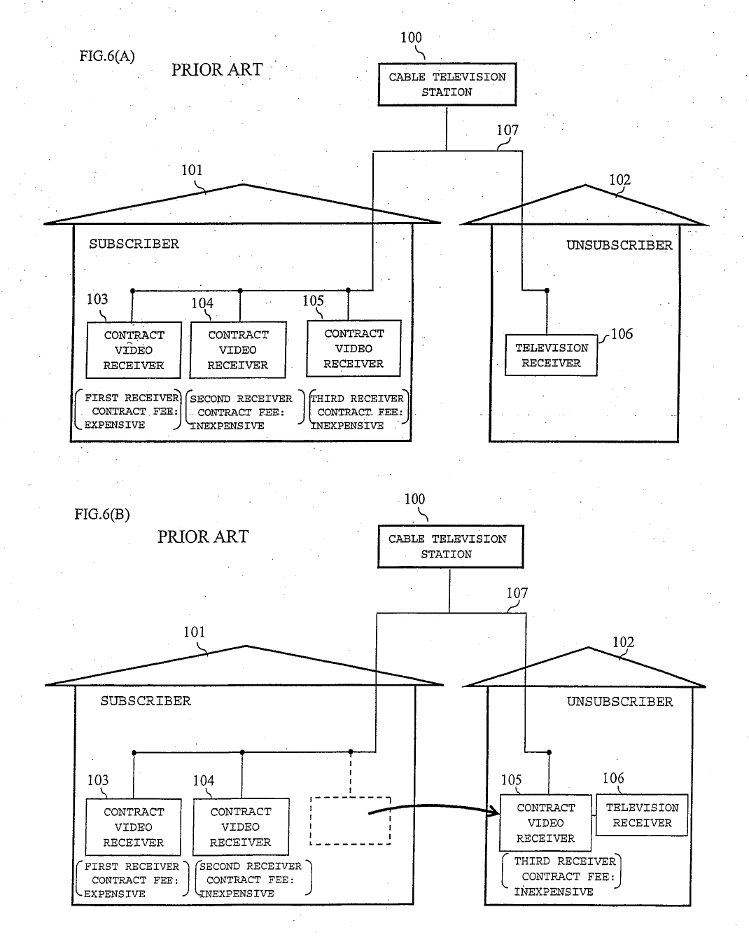

However, the case in which the “fixed videos” are displayed is not limited to the one in which the sub-contract video receiver 13 is not connected to the main-contract video receiver 12 as described above. That is, the “fixed videos” are also displayed in the case of an erroneous connection or an attempt to view broadcasting videos with an unauthorized connection as shown in FIG. 6(B). In such a case, a warning video such as notification of normal use or a soliciting advertisement broadcasting video can be displayed. The warning video such as the notification of normal use or the soliciting advertisement broadcasting video corresponds to an example of a warning video urging normal use in accordance with the present invention.

The method of “detection of established connection with the main-contract video receiver 12” executed by the home connection unit 32 is not limited by the specific contents of the connection provided that the method allows the established connection with the main-contract video receiver 12 to be confirmed. The “detection of established connection” may be determined using, for example, establishment of a physical link with the main-contract video receiver 12, successful password exchange, or successful packet exchange.

On the other hand, the “detection of unestablished connection with the main-contract video receiver 12” by the home connection unit 32 is the determination that the established connection with the main-contract video receiver 12 cannot be confirmed. The determination may be made on the basis of, for example, a failure to establish a physical link with the main-contract video receiver 12 or to achieve password or packet exchange in a predetermined time. In short, any layer in an OSI reference model can be used to confirm the connection.

The above-described process in each block of the sub-contract video receiver 13 may be implemented by either hardware or software.

For example, all of the processing by the main-contract connection detecting unit 33 may be implemented by software. In this case, the main-contract connection detecting unit 33 is a program executed by a CPU. A memory stores a flag indicating the connection status of the home network 15 detected by the home connection unit 32 and a flag indicating a power supply status detected by the power supply detecting unit 31. The flags on the memory are loaded into the main-contract connection detecting unit 33. In accordance with the statuses of the flags, the main-contract connection detecting unit 33 makes determination for “contract channel viewability”. The main-contract connection detecting unit 33 then writes a “contract channel viewability” flag indicating the result of the determination to the memory. The “contract channel viewability” flag is loaded into the broadcasting video tuner unit 34, which operates in accordance with the status of the flag.

In the description of FIG. 2, the main-contract video receiver 12 has a configuration different from that of the sub-contract video receiver 13. However, the main-contract video receiver 12 and the sub-contract video receiver 13 have the same configuration.

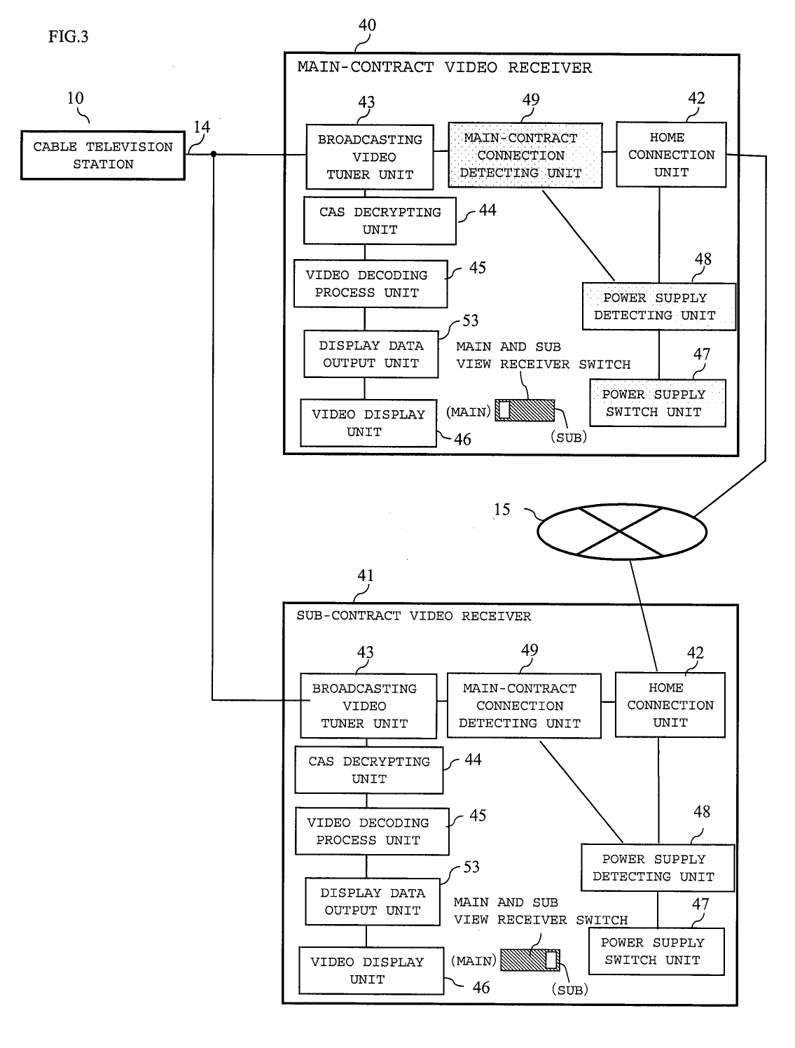

FIG. 3 is a block diagram showing connections made in the cable television receiving system in which video receivers of the same configuration are used as a main-contract video receiver and a sub-contract video receiver.

As shown in FIG. 3, a main-contract video receiver 40 and a sub-contract video receiver 41 in this case have the same configuration.

A home connection unit 42, a broadcasting video tuner unit 43, a CAS decrypting unit 44, a video decoding process unit 45, a display data output unit 53, a video display unit 46, a power supply switch unit 47, a power supply detecting unit 48, and a main-contract connection detecting unit 49 in FIG. 3 have the same functions as the home connection unit 32, broadcasting video tuner unit 34, CAS decrypting unit 35, video decoding process unit 36, display data output unit 38, video display unit 37, power supply switch unit 30, power supply detecting unit 31, and main-contract connection detecting unit 33, shown in FIG. 2, respectively.

A main and sub video view receiver switch 55 switches each of the video receivers so that the video receiver operates as a main-contract video receiver or a sub-contract video receiver. The main and sub video view receiver switch 55 for the video receiver operating as the main-contract video receiver 40 is set on the main-contract video receiver side. The main and sub video view receiver switch 55 for the video receiver operating as the sub-contract video receiver 41 is set on the sub-contract video receiver side.

In FIG. 3, shaded blocks show that the corresponding functions are not active. In this case, in the main-contract video receiver 40, since the main and sub view receiver switch 55 is set on the main-contract video receiver side, the functions of the power supply switch unit 47, the power supply detecting unit 48, and the main-contract connection detecting unit 49 which need to operate only in the case of a sub-contact video receiver are inactive.

With this configuration, the main-contract video receiver 40 and the sub-contract video receiver 41, shown in FIG. 3, have the same configuration and operate similarly to the main-contract video receiver 12 and the sub-contract video receiver 13, respectively, shown in FIG. 2.

Thus, video receivers of the same configuration can be used as either a main-contract video receiver or a sub-contract video receiver simply by making it possible to determine whether a first video receiver is the main-contract video receiver or the sub-contract video receiver and whether a second video receiver connected to the first video receiver by the home network 15 is a main-contract video receiver or a sub-contract video receiver.

The method of determining whether the video receiver is a main-contract video receiver or a sub-contract video receiver is not limited to the one using the switch as shown in FIG. 3. However, any method may be used provided that the method cannot be easily rewritten by the user. For example, a flag for determining whether the video receiver is a main-contract video receiver or a sub-contract video receiver may be provided in a ROM. The value of the flag advancely predetermined may be varied according to the video receivers. Alternatively, a predetermined wiring pattern on a circuit board may be short-circuited or disconnected to allow the determination of whether the video receiver is a main-contract video receiver or a sub-contract video receiver.

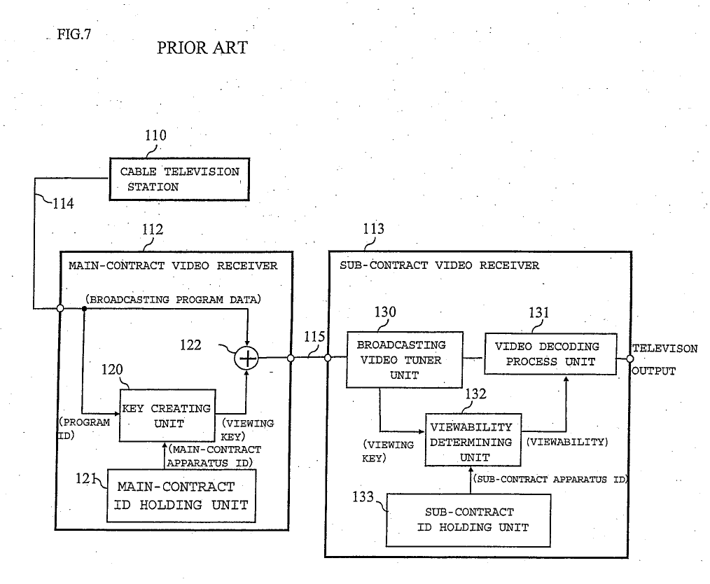

In the configuration of the conventional inter-terminal control system shown in FIG. 7, the subscriber's second or subsequent video receiver (the sub-contract video receiver 113 in FIG. 7) can receive broadcasting videos only via the main-contract video receiver 112. The sub-contract video receiver 113 can receive broadcasting programs only when acquiring the viewing key from the main-contract video receiver 112. The sub-contract video receiver 113 does not have a function of independently receiving broadcasting like the main-contract video receiver 112.

That is, the sub-contract video receiver 113 needs to be a dedicated terminal configured differently from the main-contract video receiver 112.

In contrast, in the cable television receiving system in accordance with Embodiment 1, the main-contract video receiver and the sub-contract video receiver can have the same configuration and are compatible and may thus be general-purpose apparatuses.

The cable television receiving system in accordance with Embodiment 1 enables a viewer in the subscriber's house to receive and view all the videos on the main-contract video receiver 12. As is the case with the main-contract video receiver 12, all the videos can be received and viewed on the sub-contract video receiver connected to the main-contract video receiver 12 by the home network 15. However, the sub-contract video receiver not connected to the main-contract video receiver 12 by the home network 15 can receive only the fixed broadcasting videos on the cable television line 14. This enables the viewing to be controlled.

### Embodiment 2

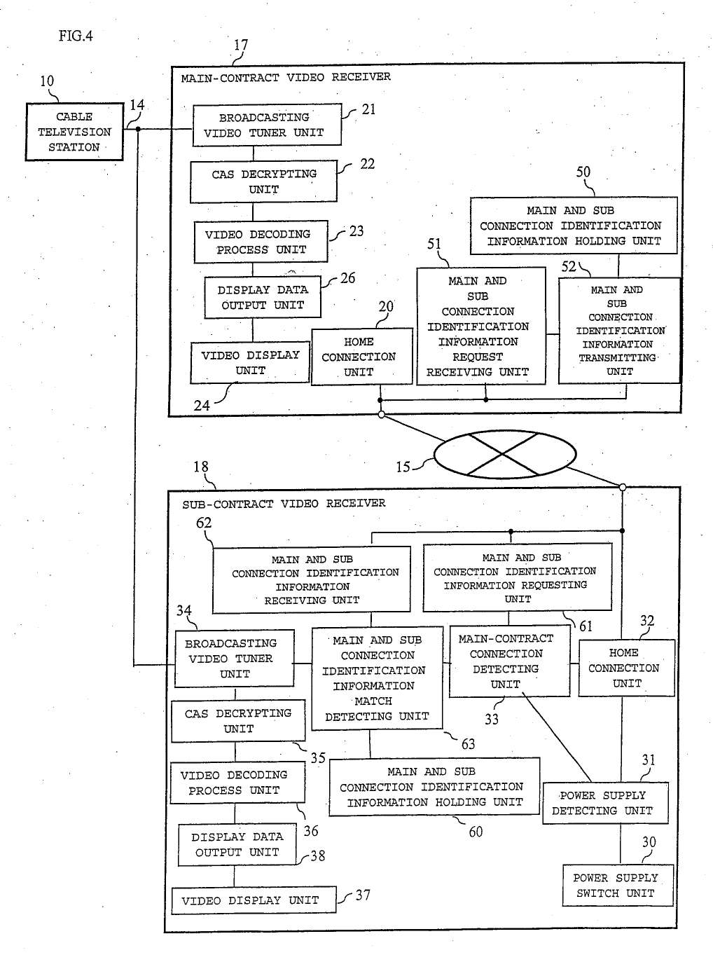

FIG. 4 is a block diagram showing the connection between the main-contract video receiver 17 and the sub-contract video receiver 18 in a cable television receiving system in accordance with Embodiment 2 of the present invention. The same components as those in FIG. 2 for Embodiment 1 are denoted by the same reference numerals and will thus not be described.

The configuration of connections in the cable television receiving system in accordance with Embodiment 2 is similar to that in accordance with Embodiment 1, shown in FIG. 1. One main-contract video receiver 17 is connected to each of at least one sub-contract video receiver 18 by the home network 15. The cable television line 14 is connected to each of the main-contract video receiver 17 and the sub-contract video receiver 18.

In FIG. 4, the main-contract video receiver 17 comprises not only the components of the main-contract video receiver 12, shown in FIG. 2, but also a main and sub connection identification information holding unit 50, a main and sub connection identification information request receiving unit 51, and a main and sub identification information transmitting unit 52.

A home connection unit 20 corresponds to an example of a network connection unit in accordance with the present invention.

The main and sub connection identification information holding unit 50 holds main and sub connection identification information that is unique in connection with the sub-contract video receiver 18. The main and sub connection identification information request receiving unit 51 receives a main and sub connection identification information request from the sub-contract video receiver 18. In response to the main and sub connection identification information request from the sub-contract video receiver 18, the main and sub connection identification information transmitting unit 52 transmits the main and sub connection identification information held in the main and sub connection identification information holding unit 50.

The unique main and sub connection identification information held by the main and sub connection identification information holding unit 50 corresponds to an example of first identification information in accordance with the present invention. The main and sub connection identification information holding unit 50 corresponds to an example of a first identification information holding unit in accordance with the present invention. The main and sub connection identification information transmitting unit 52 corresponds to an example of a first identification information transmitting unit in accordance with the present invention.

The sub-contract video receiver 18 comprises not only the components of the sub-contract video receiver 13, shown in FIG. 2, but also a main and sub connection identification information holding unit 60, a main and sub connection identification information requesting unit 61, a main and sub connection identification information receiving unit 62, and a main and sub connection identification information match detecting unit 63.

The main and sub connection identification information holding unit 60 holds main and sub connection identification information that is unique in connection with the main-contract video receiver 17. That is, the main and sub connection identification information holding unit 60 holds the main and sub connection identification information of the same value as that of the main and sub connection identification information in the main and sub connection identification information holding unit 50 of the main-contract video receiver 17.

The main and sub connection identification information requesting unit 61 requests main and sub connection identification information from the main-contract video receiver 17. The main and sub connection identification information receiving unit 62 receives the main and sub connection identification information from the main-contract video receiver 17. The main and sub connection identification information match detecting unit 63 detects a match between the main and sub connection identification information received by the main and sub connection identification information receiving unit 62 and the main and sub connection identification information held by the main and sub connection identification information holding unit 60.

The unique main and sub connection identification information held by the main and sub connection identification information holding unit 60 corresponds to an example of second identification information in accordance with the present invention. The main and sub connection identification information holding unit 60 corresponds to a second identification information holding unit in accordance with the present invention. The main and sub connection identification information requesting unit 61 corresponds to an example of an identification information requesting unit in accordance with the present invention. The main and sub connection identification information receiving unit 62 corresponds to an example of an identification information receiving unit in accordance with the present invention. The main and sub connection identification information match detecting unit 63 corresponds to an example of a video reception control unit in accordance with the present invention.

Now, description will be given of the operation of the cable television receiving system in accordance with Embodiment 2 in which the main-contract video receiver 17 and the sub-contract video receiver 18 receive broadcasting videos from the cable television station 10.

The description of the following operation is omitted because the operations are the same as those in Embodiment 1: the operation performed by the main-contract video receiver 17 to receive broadcasting videos and the operation of receiving broadcasting videos performed by the sub-contract video receiver 18 not connected to the main-contract video receiver 17 by the home network 15.

Description will be given below of the operation performed by the sub-contract video receiver 18 to receive broadcasting videos when the sub-contract video receiver 18 is connected to the main-contract video receiver 17 by the home network 15. Separate description will be given of the operation performed if the main and sub connection identification information received from the main-contract video receiver 17 matches the main and sub connection identification information held by the sub-contract video receiver 18 and the operation performed if these two pieces of main and sub connection identification information do not match.

First, description will be given of the operation performed by the sub-contract video receiver 18 to receive broadcasting videos if the main and sub connection identification information received from the main-contract video receiver 17 matches the main and sub connection identification information held by the sub-contract video receiver 18.

When the user turns on the power supply switch unit 30 in order to allow the sub-contract video receiver 18 to receive videos, the power supply detecting unit 31 confirms that the power supply switch unit 30 has been turned on. When the power supply detecting unit 31 confirms that the power is on, the home connection unit 32 connects the sub-contract video receiver 18 to the main-contract video receiver 17 via the home network 15.

When the main and sub connection detecting unit 33 recognizes that the power supply detecting unit 31 has detected the power-on and that the home connection unit 32 has detected the established connection with the main-contract video receiver 17, the main and sub connection identification information requesting unit 61 requests, via the home network 15, the main-contract video receiver 17 to transmit main and sub connection identification information.

The main and sub connection identification information request receiving unit 51 of the main-contract video receiver 17 receives the request for transmission of the main and sub connection identification information from the sub-contract video receiver 18. When the main and sub connection identification information request receiving unit 51 receives the request from the sub-contract video receiver 18, the main and sub connection identification information transmitting unit 52 transmits the main and sub connection identification information held by the main and sub connection identification information holding unit 50, to the sub-contract video receiver 18 via the home network 15.

When the main and sub connection identification information receiving unit 62 of the sub-contract video receiver 18 receives the main and sub connection identification information from the main-contract video receiver 17, the main and sub connection identification information match detecting unit 63 compares the main and sub connection identification information received by the main and sub connection identification information receiving unit 62 and the main and sub connection identification information held by the main and sub connection identification information holding unit 60. The main and sub connection identification information match detecting unit 63 confirms that these two pieces of main and sub connection identification information match and notifies the broadcasting video tuner unit 34 of the match.

The broadcasting video tuner unit 34 receives broadcasting videos distributed through the cable television line 14 by the cable television station 10. In response to the notification from the main and sub connection identification information match detecting unit 63 indicating a “match with the main and sub connection identification information in the main-contract video receiver 17”, the broadcasting video tuner unit 34 then selects a channel through which all the encrypted videos are to be viewed.

The CAS decrypting unit 35 uses “key information” that is decryption information for CAS (conditional access system) to decrypt broadcasting videos of the channel selected by the broadcasting video tuner unit 34. The video decoding process unit 36 decodes the video signals decrypted by the CAS decrypting unit 35. Display data resulting from the decoding by the video decoding process unit 36 is then output by the display data output unit 38. The video display unit 37 then displays the data as videos.

Now, description will be given of the operation performed by the sub-contract video receiver 18 to receive broadcasting videos if the main and sub connection identification information received from the main-contract video receiver 17 does not match the main and sub connection identification information held by the sub-contract video receiver 18.

When the user turns on the power supply switch unit 30 in order to allow the sub-contract video receiver 18 to receive videos, the power supply detecting unit 31 confirms that the power supply switch unit 30 has been turned on. When the power supply detecting unit 31 confirms that the power is on, the home connection unit 32 connects the sub-contract video receiver 18 to the main-contract video receiver 17 via the home network 15.

When the main and sub connection detecting unit 33 recognizes that the power supply detecting unit 31 has detected the power-on and that the home connection unit 32 has detected the established connection with the main-contract video receiver 17, the main and sub connection identification information requesting unit 61 requests, via the home network 15, the main-contract video receiver 17 to transmit main and sub connection identification information.

The main and sub connection identification information request receiving unit 51 of the main-contract video receiver 17 receives the request for transmission of the main and sub connection identification information from the sub-contract video receiver 18. When the main and sub connection identification information request receiving unit 51 receives the request from the sub-contract video receiver 18, the main and sub connection identification information transmitting unit 52 transmits the main and sub connection identification information held by the main and sub connection identification information holding unit 50, to the sub-contract video receiver 18 via the home network 15.

When the main and sub connection identification information receiving unit 62 of the sub-contract video receiver 18 receives the main and sub connection identification information from the main-contract video receiver 17, the main and sub connection identification information match detecting unit 63 compares the main and sub connection identification information received by the main and sub connection identification information receiving unit 62 and the main and sub connection identification information held by the main and sub connection identification information holding unit 60. The main and sub connection identification information match detecting unit 63 confirms that these two pieces of main and sub connection identification information do not match and notifies the broadcasting video tuner unit 34 of the mismatch.

The broadcasting video tuner unit 34 receives broadcasting videos distributed through the cable television line 14 by the cable television station 10. In response to the notification from the main and sub connection identification information match detecting unit 63 indicating a “mismatch with the main and sub connection identification information in the main-contract video receiver 17”, the broadcasting video tuner unit 34 selects a fixed channel through which only encrypted fixed videos are viewed.

The CAS decrypting unit 35 uses “key information” that is decryption information for CAS (limited reception system) to decrypt broadcasting videos of the fixed channel selected by the broadcasting video tuner unit 34. The video decoding process unit 36 decodes the broadcasting videos of the fixed channel decrypted by the CAS decrypting unit 35. Display data resulting from the decoding by the video decoding process unit 36 is then output by the display data output unit 38. The video display unit 37 then displays the data as fixed videos. The contents of the fixed videos are similar to those in Embodiment 1.

The above-described process in each block of the main-contract video receiver 17 and sub-contract video receiver 18 may be implemented by either hardware or software.

For example, to allow a program executed by the CPU to cause the main and sub connection identification information transmitting unit 52 to execute the appropriate process, the following operation is possible. When the main and sub connection identification information request receiving unit 51 receives the request for the main and sub connection identification information from the sub-contract video receiver 18, the main and sub connection identification information transmitting unit 52 starts the process. The main and sub connection identification information transmitting unit 52 acquires the main and sub connection identification information written in a predetermined area on a memory serving as the main and sub connection identification information holding unit 50. The main and sub connection identification information transmitting unit 52 then writes the main and sub connection identification information to a transmission buffer for transmission to the sub-contract video receiver 18 via the home network 15.

For example, to allow a program executed by the CPU to cause the main and sub connection identification information requesting unit 61 to execute the appropriate process, the following operation is possible. A memory stores a flag indicating the connection status of the home network 15 detected by the home connection unit 32 and a flag indicating a power supply status detected by the power supply detecting unit 31. The flags on the memory are loaded into the main and sub connection identification information requesting unit 61. Upon determining the need to request the main and sub connection identification information from the main-contract video receiver 17 on the basis of the flag status, the main and sub connection identification information requesting unit 61 writes a message requesting the main and sub connection identification information from the main-contract video receiver 17, to the transmission buffer for transmission to the main-contract video receiver 17 via the home network 15.

For example, to allow a program executed by the CPU to cause the main and sub connection identification information match detecting unit 63 to execute the appropriate process, the following operation is possible. The main and sub connection identification information received by the main and sub connection identification information receiving unit 62 is written in a predetermined area on a memory. The main and sub connection identification information match detecting unit 63 acquires the main and sub connection identification information written to the memory and the main and sub connection identification information written in the different predetermined area on the memory serving as the main and sub connection identification information holding unit 60. The main and sub connection identification information match detecting unit 63 then compares the loaded two pieces of main and sub connection identification information and writes, to the memory, a “match or mismatch of main and sub connection identification information” flag indicating the result of the comparison. The “match or mismatch of main and sub connection identification information” flag is loaded into the broadcasting video tuner unit 34, which then operates in accordance with the flag status.

The cable television receiving system in accordance with Embodiment 2 enables the viewer in the subscriber's house to receive and view all the videos on the main-contract video receiver 17. As is the case with the main-contract video receiver 17, all the videos can be received by and viewed on the sub-contract video receiver connected to the main-contract video receiver 17 by the home network 15 and holding the main and sub connection identification information matching the main and sub connection identification information in the main-contract video receiver 17. However, the sub-contract video receiver 18 can receive only the fixed broadcasting videos on the cable television line 14 if the video receiver 18 is not connected to the main-contract video receiver 17 by the home network 15 or if the video receiver 18 is connected to the main-contract video receiver 17 by the home network 15 but holds main and sub connection identification information not matching the main and sub connection identification information in the main-contract video receiver 17. This enables the viewing to be controlled.

For example, for each subscriber, the main-contract video receiver and sub-contract video receiver covered by the regular contract hold the same main and sub connection identification information. Then, even if the subscriber obtains another video receiver not covered by the contract and attempts to view broadcasting videos on video receivers the number of which exceeds the regular value specified in the contract, a mismatch of the main and sub connection identification information prevents the viewing with the video receiver not covered by the contract. This makes it possible to limit the viewing with more video receivers than specified in the contract. That is, the present embodiment makes it possible to limit the unauthorized viewing with video receivers the number of which exceeds the regular value specified in the contract.

In Embodiment 2, upon recognizing the detection of the power-on and the established connection with the main-contract video receiver 17, the sub-contract video receiver 18 requests the main-contract video receiver 17 to transmit the main and sub connection identification information. However, upon recognizing the detection of established connection with the sub-contract video receiver 18, the main-contract video receiver 17 may transmit the main and sub connection identification information to the sub-contract video receiver 18 without any request from the sub-contract video receiver 18.

### Embodiment 3

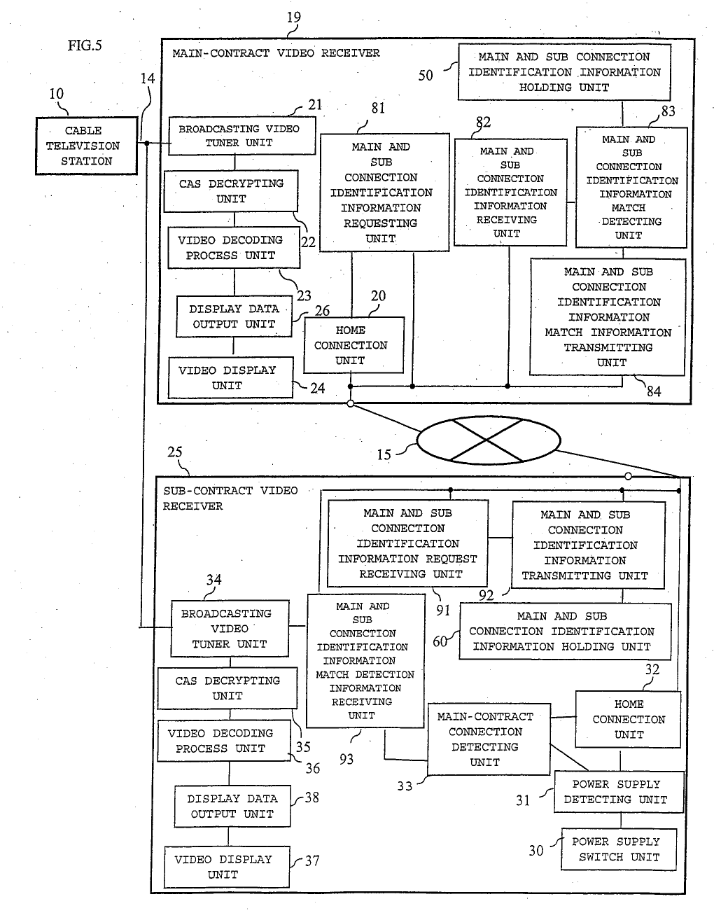

FIG. 5 is a block diagram showing the connection between a main-contract video receiver 19 and a sub-contract video receiver 25 in a cable television receiving system in accordance with Embodiment 3 of the present invention. The same components as those in FIGS. 2 and 4 are denoted by the same reference numerals and will thus not be described.

The configuration of connections in the cable television receiving system in accordance with Embodiment 3 is similar to that in accordance with Embodiment 1, shown in FIG. 1. One main-contract video receiver 19 is connected to each of at least one sub-contract video receiver 25 by the home network 15. The cable television line 14 is connected to each of the main-contract video receiver 19 and the sub-contract video receiver 25.

In FIG. 5, the main-contract video receiver 19 comprises not only the components of the main-contract video receiver 12, shown in FIG. 2, but also the main and sub connection identification information holding unit 50, a main and sub connection identification information requesting unit 81, a main and sub connection identification information receiving unit 82, a main and sub connection identification information match detecting unit 83, and a main and sub connection identification information match information transmitting unit 84.

The main and sub connection identification information requesting unit 81 requests main and sub connection identification information from the sub-contract video receiver 25. The main and sub connection identification information receiving unit 82 receives the main and sub connection identification information from the sub-contract video receiver 25. The main and sub connection identification information match detecting unit 83 detects a match between the main and sub connection identification information received by the main and sub connection identification information receiving unit 82 and the main and sub connection identification information held by the main and sub connection identification information holding unit 50. The main and sub connection identification information match information transmitting unit 84 transmits, to the sub-contract video receiver 25, main and sub connection identification information match detection information indicating a match or mismatch based on the detection by the main and sub connection identification information match detecting unit 83.

The main and sub connection identification information match detection information corresponds to an example of determination information in accordance with the present invention. The main and sub connection identification information match information transmitting unit 84 corresponds to an example of a determination information transmitting unit.

In FIG. 5, the sub-contract video receiver 25 comprises not only the components of the sub-contract video receiver 13, shown in FIG. 2, but also a main and sub connection identification information holding unit 60, a main and sub connection identification information request receiving unit 91, a main and sub connection identification information transmitting unit 92, and a main and sub connection identification information match detection information receiving unit 93.

The main and sub connection identification information request receiving unit 91 receives the main and sub connection identification information request from the main-contract video receiver 19. In response to the main and sub connection identification information request from the main-contract video receiver 19, the main and sub connection identification information transmitting unit 92 transmits the main and sub connection identification information held by the main and sub connection identification information holding unit 60 to the main-contract video receiver 19. The main and sub connection identification information match detection information receiving unit 93 receives the main and sub connection identification information match detection information transmitted by the main-contract video receiver 19.

The main and sub connection identification information transmitting unit 92 corresponds to an example of a second identification information transmitting unit in accordance with the present invention. The main and sub connection identification information match detection information receiving unit 93 corresponds to an example of a determination information receiving unit and a video reception control unit.

Now, description will be given of the operation of the cable television receiving system in accordance with Embodiment 3 in which the main-contract video receiver 19 and the sub-contract video receiver 25 receive broadcasting videos from the cable television station 10.

The description of the following operation is omitted because the operation is the same as that in Embodiment 1: the operation performed by the main-contract video receiver 19 to receive broadcasting videos and the operation of receiving broadcasting videos performed by the sub-contract video receiver 25 not connected to the main-contract video receiver 19 by the home network 15.

Description will be given below of the operation performed by the sub-contract video receiver 25 to receive broadcasting videos when the sub-contract video receiver 25 is connected to the main-contract video receiver 19 by the home network 15. Separate description will be given of the operation performed if the main and sub connection identification information held by the main-contract video receiver 19 matches the main and sub connection identification information held by the sub-contract video receiver 25 and the operation performed if these two pieces of main and sub connection identification information do not match.

First, description will be given of the operation performed by the sub-contract video receiver 25 to receive broadcasting videos if the main and sub connection identification information held by the main-contract video receiver 19 matches the main and sub connection identification information held by the sub-contract video receiver 25.

When the user turns on the power supply switch unit 30 in order to allow the sub-contract video receiver 25 to receive videos, the power supply detecting unit 31 confirmed that the power supply switch unit 30 has been turned on. When the power supply detecting unit 31 confirms that the power is on, the home connection unit 32 connects the sub-contract video receiver 25 to the main-contract video receiver 19 via the home network 15.

Upon recognizing that the home connection unit 20 of the main-contract video receiver 19 has detected the established connection with the sub-contract video receiver 25 via the home network 15, the main and sub connection identification information requesting unit 81 requests, via the home network 15, the sub-contract video receiver 25 to transmit the main and sub connection identification information.

The main and sub connection identification information request receiving unit 91 of the sub-contract video receiver 25 receives the request for the main and sub connection identification information from the main-contract video receiver 19. When the main and sub connection identification information request receiving unit 91 receives the request from the main-contract video receiver 19, the main and sub connection identification information transmitting unit 92 transmits the unique main and sub connection identification information held by the main and sub connection identification information holding unit 60, to the main-contract video receiver 19.

When the main and sub connection identification information receiving unit 82 of the main-contract video receiver 19 receives the main and sub connection identification information from the sub-contract video receiver 25, the main and sub connection identification information match detecting unit 83 compares the main and sub connection identification information received by the main and sub connection identification information receiving unit 82 and the main and sub connection identification information held by the main and sub connection identification information holding unit 50. The main and sub connection identification information match detecting unit 83 thus confirms that these two pieces of main and sub connection identification information match. The main and sub connection identification information match information transmitting unit 84 transmits, to the sub-contract video receiver 25, main and sub connection identification information match detection information indicating a “match with the main and sub connection identification information in the sub-contract video receiver 25” based on the detection by the main and sub connection identification information match detecting unit 83.

Upon receiving the main and sub connection identification information match detection information from the main-contract video receiver 19, the main and sub connection identification information match detection information receiving unit 93 of the sub-contract video receiver 25 notifies the broadcasting video tuner unit 34 of a “match with the main and sub connection identification information in the main-contract video receiver 19”.

The broadcasting video tuner unit 34 receives broadcasting videos distributed through the cable television line 14 by the cable television station 10. In response to the notification from the main and sub connection identification information match detection information receiving unit 93 indicating the “match with the main and sub connection identification information in the main-contract video receiver 19”, the broadcasting video tuner unit 34 then selects a channel through which all the encrypted videos are to be viewed.

The CAS decrypting unit 35 uses “key information” that is decryption information for CAS (conditional access system) to decrypt broadcasting videos of the channel selected by the broadcasting video tuner unit 34. The video decoding process unit 36 decodes the broadcasting videos decrypted by the CAS decrypting unit 35. Display data resulting from the decoding by the video decoding process unit 36 is then output by the display data output unit 38. The video display unit 37 then displays the videos.

Now, description will be given of the operation performed by the sub-contract video receiver 25 to receive broadcasting videos if the main and sub connection identification information held by the main-contract video receiver 19 does not match the main and sub connection identification information held by the sub-contract video receiver 25.

When the user turns on the power supply switch unit 30 in order to allow the sub-contract video receiver 25 to receive videos, the power supply detecting unit 31 confirms that the power supply switch unit 30 has been turned on. When the power supply detecting unit 31 confirms that the power is on, the home connection unit 32 connects the sub-contract video receiver 25 to the main-contract video receiver 19 via the home network 15.

Upon recognizing that the home connection unit 20 of the main-contract video receiver 12 has detected the established connection with the sub-contract video receiver 25 via the home network 15, the main and sub connection identification information requesting unit 81 requests, via the home network 15, the sub-contract video receiver 25 to transmit the main and sub connection identification information.

The main and sub connection identification information request receiving unit 91 of the sub-contract video receiver 25 receives the request for the main and sub connection identification information from the main-contract video receiver 19. When the main and sub connection identification information request receiving unit 91 receives the request from the main-contract video receiver 19, the main and sub connection identification information transmitting unit 92 transmits the unique main and sub connection identification information held by the main and sub connection identification information holding unit 60, to the main-contract video receiver 19.

When the main and sub connection identification information receiving unit 82 of the main-contract video receiver 19 receives the main and sub connection identification information from the sub-contract video receiver 25, the main and sub connection identification information match detecting unit 83 compares the main and sub connection identification information received by the main and sub connection identification information receiving unit 82 and the main and sub connection identification information held by the main and sub connection identification information holding unit 50. The main and sub connection identification information match detecting unit 83 thus confirms that these two pieces of main and sub connection identification information do not match. The main and sub connection identification information match information transmitting unit 84 transmits, to the sub-contract video receiver 25, main and sub connection identification information match detection information indicating a “mismatch with the main and sub connection identification information in the sub-contract video receiver 25” based on the detection by the main and sub connection identification information match detecting unit 83.

Upon receiving the main and sub connection identification information match detection information from the main-contract video receiver 19, the main and sub connection identification information match detection information receiving unit 93 of the sub-contract video receiver 25 notifies the broadcasting video tuner unit 34 of a “mismatch with the main and sub connection identification information in the main-contract video receiver 19”.

The broadcasting video tuner unit 34 receives broadcasting videos distributed through the cable television line 14 by the cable television station 10. In response to the notification from the main and sub connection identification information match detection information receiving unit 93 indicating the “mismatch with the main and sub connection identification information in the main-contract video receiver 19”, the broadcasting video tuner unit 34 then selects a fixed channel through which encrypted fixed videos are to be viewed.

The CAS decrypting unit 35 uses “key information” that is decryption information for CAS (conditional access system) to decrypt broadcasting videos of the fixed channel selected by the broadcasting video tuner unit 34. The video decoding process unit 36 decodes the broadcasting videos of the fixed channel decrypted by the CAS decrypting unit 35. Display data resulting from the decoding by the video decoding process unit 36 is then output by the display data output unit 38. The video display unit 37 then displays the fixed videos. The contents of the fixed videos are similar to those in Embodiments 1 and 2.

The above-described process in each block of the main-contract video receiver 19 and sub-contract video receiver 25 may be implemented by either hardware or software.

For example, to allow a program executed by the CPU to cause the main and sub connection identification information match information transmitting unit 84 to execute the appropriate process, the following operation is possible. The main and sub connection identification information match detecting unit 83 writes a “match or mismatch of main and sub connection identification information” flag, the result of comparison of the main and sub connection identification information, in a predetermined area on a memory. The main and sub connection identification information match detecting unit 83 also allows the main and sub connection identification information match information transmitting unit 84 to start the process. The main and sub connection identification information match information transmitting unit 84 acquires the “match or mismatch of main and sub connection identification information” flag written to the memory. The main and sub connection identification information match information transmitting unit 84 then writes the “match or mismatch of main and sub connection identification information” information to a transmission buffer for transmission to the sub-contract video receiver 25 via the home network 15.

For example, to allow a program executed by the CPU to cause the main and sub connection identification information transmitting unit 92 to execute the appropriate process, the following operation is possible. When the main and sub connection identification information request receiving unit 91 receives the main and sub connection identification information request from the main-contract video receiver 19, the main and sub connection identification information transmitting unit 92 starts the process. The main and sub connection identification information transmitting unit 92 acquires the main and sub connection identification information written in a predetermined area on a memory serving as the main and sub connection identification information holding unit 60. The main and sub connection identification information transmitting unit 92 then writes the main and sub connection identification information to a transmission buffer for transmission to the main-contract video receiver 19 via the home network 15.

For example, to allow a program executed by the CPU to cause the main and sub connection identification information match detection information receiving unit 93 to execute the appropriate process, the following operation is possible. When the “match or mismatch of main and sub connection identification information” information is stored in a reception buffer, the main and sub connection identification information match detection information receiving unit 93 starts the process. The main and sub connection identification information match detection information receiving unit 93 acquires the “match or mismatch of main and sub connection identification information” information stored in the reception buffer. The main and sub connection identification information match detection information receiving unit 93 then writes the “match or mismatch of main and sub connection identification information” flag corresponding to the “match or mismatch of main and sub connection identification information” information, in a predetermined area of a memory. The “match or mismatch of main and sub connection identification information” flag is loaded into the broadcasting video tuner unit 34, which then operates in accordance with the status of the flag.

The cable television receiving system in accordance with Embodiment 3 enables the viewer to receive and view all the videos on the main-contract video receiver 19. As is the case with the main-contract video receiver 19, all the videos can be received by and viewed on the sub-contract video receiver connected to the main-contract video receiver 19 by the home network 15 and holding the main and sub connection identification information matching the main and sub connection identification information in the main-contract video receiver 19. However, the sub-contract video receiver can receive only the fixed broadcasting videos on the cable television line 14 if the sub-contract video receiver is not connected to the main-contract video receiver 19 by the home network 15 or if the sub-contract video receiver is connected to the main-contract video receiver 19 by the home network 15 but holds main and sub connection identification information not matching the main and sub connection identification information in the main-contract video receiver 19. This enables the viewing to be controlled.

In Embodiment 3, upon detecting the established connection with the sub-contract video receiver 25 via the home network 15, the main-contract video receiver 19 requests the sub-contract video receiver 25 to transmit the main and sub connection identification information. However, when the sub-contract video receiver 25 recognizes the detection of the power-on and the established connection with the main-contract video receiver 19, the main and sub connection identification information transmitting unit 92 may transmit the main and sub connection identification information directly to the main-contract video receiver 19 without any request from the main-contract video receiver 19.

The main-contract video receivers and sub-contract video receivers in the embodiments are, for example, cable television STBs (Set Top Boxes).

In the description of the embodiments, each of the video receivers comprises the video display unit. However, according to the present invention, the video display unit need not be provided in the video receiver. In this case, for example, a display such as a television is connected to a connector connected to the display data output unit to display decoded videos.

In the description of the embodiments, each of the video receives comprises the CAS decrypting unit. However, according to the present invention, the CAS decrypting unit also need not be provided in the video receiver. In this case, a CAS card inserted into the video receiver is utilized to execute a CAS decrypting process.

Furthermore, each of the sub-contract video receivers comprises the CAS decrypting unit and thus has the CAS decrypting function. This eliminates the need to pass an encryption key between the main-contract video receiver and the sub-contract video receiver. That is, the video receivers need not share any CAS encryption key. Thus, the cable television receiving system in accordance with each of the embodiments is applicable not only to analog broadcasting but also to digital broadcasting.

In the description of the embodiments, the home network 15, connecting the main-contract video receiver and the sub-contract video receiver together, is connected to the video receivers using the cables different from the cable television line 14. However, the home network may be constructed utilizing the cable television line 14. In this case, the main-contract video receiver and the sub-contract video receiver communicate using a frequency band different from that used for data from the cable television station such as broadcasting program data. Furthermore, in this case, the main-contract video receiver and the sub-contract video receiver communicate via a distributor. The cable television line 14 in this case is an example of wiring through which video signals are distributed in accordance with the present invention.

Instead of the wiring, radio may be used for the connections of the home network 15, connecting the main-contract video receiver and the sub-contract video receiver together.

As illustrated in FIG. 3, when each video receiver has both the functions required for the main-contract video receiver and the functions required for the sub-contract video receiver so as to provide the function of determining whether that video receiver is the main-contract video receiver or the sub-contract video receiver, the main-contract video receivers and sub-contract video receivers in Embodiments 2 and 3 may have the same configuration.

The sub-contract video receiver in the conventional inter-terminal control system such as the one shown in FIG. 7 must be a dedicated apparatus because the sub-contract video receiver cannot achieve reception without an established connection with the main-contract video receiver. However, the sub-contract video receiver in accordance with the present invention has a function of independently receiving broadcasting program data. The sub-contract video receiver in accordance with the present invention may thus have the same configuration as that of the main-contract video receiver and may be a general-purpose apparatus.

The program in accordance with the present invention allows a computer to execute the functions of the video reception control unit of the above-described sub-contract video receiver in accordance with the present invention; the video reception control unit allows the video receiving tuner unit to receive video signals of the limited predetermined channel if the sub-contract video receiver is not connected to the main-contract video receiver by the network. The program operates in cooperation with the computer.

The recording medium in accordance with the present invention is a recording medium in which a program is recorded which allows a computer to execute the functions of the video reception control unit of the above-described sub-contract video receiver in accordance with the present invention; the video reception control unit allows the video receiving tuner unit to receive video signals of the limited predetermined channel if the sub-contract video receiver is not connected to the main-contract video receiver by the network. The computer can read data from the recording medium, and the read program operates in cooperation with the computer.

The program in accordance with the present invention allows the computer to execute the functions of the first identification information holding unit of the main-contract video receiver in accordance with the present invention, which pre-holds the unique first identification information, and the functions of the first identification information transmitting unit of the main-contract video receiver in accordance with the present invention, which transmits the first identification information in response to the request for transmission of the first identification information from the sub-contract video receiver via the network. The program operates in cooperation with the computer.

The program in accordance with the present invention allows the computer to execute the functions of the first identification information holding unit of the main-contract video receiver in accordance with the present invention, which pre-holds the unique first identification information, and the functions of the determination information transmitting unit of the main-contract video receiver in accordance with the present invention, which transmits, to the sub-contract video receiver, the determination information indicating whether or not the second identification information received from the sub-contract video receiver via the network matches the first identification information pre-held in the first identification information holding unit. The program operates in cooperation with the computer.

The recording medium in accordance with the present invention is a recording medium in which a program is recorded which allows the computer to execute the functions of the first identification information holding unit of the main-contract video receiver in accordance with the present invention, which pre-holds the unique first identification information, and the functions of the first identification information transmitting unit of the main-contract video receiver in accordance with the present invention, which transmits the first identification information in response to the request for transmission of the first identification information from the sub-contract video receiver via the network. The computer can read data from the recording medium, and the read program operates in cooperation with the computer.

The recording medium in accordance with the present invention is a recording medium in which a program is recorded which allows the computer to execute the functions of the first identification information holding unit of the main-contract video receiver in accordance with the present invention, which pre-holds the unique first identification information, and the functions of the determination information transmitting unit of the main-contract video receiver in accordance with the present invention, which transmits, to the sub-contract video receiver, the determination information indicating whether or not the second identification information received from the sub-contract video receiver via the network matches the first identification information pre-held in the first identification information holding unit. The computer can read data from the recording medium, and the read program operates in cooperation with the computer.

The program in accordance with the present invention allows the computer to execute the functions of the identification information transmitting unit of the video receiving system in accordance with the present invention, which transmits the first identification information in response to the request for the first identification information from the sub-contract video receiver, the functions of the identification information requesting unit of the video receiving system in accordance with the present invention, which transmits the request for transmission of the first identification information to the main-contract video receiver when the established connection with the main-contract video receiver via the network is detected, and the functions of the video reception control unit of the video receiving system in accordance with the present invention, which, even when the established connection with the main-contract video receiver via the network is detected, allows the video receiving tuner unit to receive video signals of the limited predetermined channel if the first identification information does not match the second identification information. The program operates in cooperation with the computer.

The recording medium in accordance with the present invention is a recording medium in which a program is recorded which allows the computer to execute the functions of the identification information transmitting unit of the video receiving system in accordance with the present invention, which transmits the first identification information in response to the request for the first identification information from the sub-contract video receiver, the functions of the identification information requesting unit of the video receiving system in accordance with the present invention, which transmits the request for transmission of the first identification information to the main-contract video receiver when the established connection with the main-contract video receiver via the network is detected, and the functions of the video reception control unit of the video receiving system in accordance with the present invention, which, even when the established connection with the main-contract video receiver via the network is detected, allows the video receiving tuner unit to receive video signals of the limited predetermined channel if the first identification information does not match the second identification information. The computer can read data from the recording medium, and the read program operates in cooperation with the computer.

The program in accordance with the present invention allows the computer to execute the functions of the determination information transmitting unit of the video receiving system in accordance with the present invention, which transmits, to the sub-contract video receiver, the determination information indicating whether or not the second identification information matches the first identification information, the second identification information transmitting unit of the video receiving system in accordance with the present invention, which transmits the second identification information to the main-contract video receiver when the established connection with the main-contract video receiver via the network is detected, and the functions of the video reception control unit of the video receiving system in accordance with the present invention, which, even when the established connection with the main-contract video receiver via the network is detected, allows the video receiving tuner unit to receive video signals of the limited predetermined channel if the determination information received from the main-contract video receiver indicates the mismatch between the second identification information and the first identification information. The program operates in cooperation with the computer.

The recording medium in accordance with the present invention is a recording medium in which a program is recorded which allows the computer to execute the functions of the determination information transmitting unit of the video receiving system in accordance with the present invention, which transmits, to the sub-contact video receiver, the determination information indicating whether or not the second identification information matches the first identification information, the second identification information transmitting unit of the video receiving system in accordance with the present invention, which transmits the second identification information to the main-contract video receiver when the established connection with the main-contract video receiver via the network is detected, and the functions of the video reception control unit of the video receiving system in accordance with the present invention, which, even when the established connection with the main-contract video receiver via the network is detected, allows the video receiving tuner unit to receive video signals of the limited predetermined channel if the determination information received from the main-contract video receiver indicates the mismatch between the second identification information and the first identification information. The computer can read data from the recording medium, and the read program operates in cooperation with the computer.

In one aspect, the program in accordance with the present invention may be recorded in the computer readable recording medium and operates in cooperation with the computer.

An example of the recording medium is a ROM.

The computer in accordance with the present invention may include not only pure hardware such as a CPU, but also firmware or an OS or even peripheral equipment.

As described above, the configuration of the present invention may be implemented using either software or hardware.

As described above, the video receiving system in accordance with the present invention exerts the following effects. It is assumed that the main-contract video receiver and sub-contract video receiver, included in the plurality of cable television video receivers covered by the contract, each have unique information and are connected together by the home network. When the sub-contract video receiver is powered on, if the appropriate link has been unestablished or the unique information in the main-contract video receiver does not match the unique information in the sub-contract video receiver, the receiving tuner automatically selects the advertising program channel of the provider to preclude the normal broadcasting program channel from being received. This makes it possible to inhibit the unauthorized use of the sub-contract video receiver and to increase the number of subscribers to the provider by transmitting the notification of normal use and soliciting advertisement broadcasting videos.

The video receiving system, sub-contract video receiver, video receiving method, and the like in accordance with the present invention are effective for limiting the viewing with unauthorized video receivers and allowing only the videos of the particular channel to be viewed during viewing limitation. The video receiving system, sub-contract video receiver, video receiving method, and the like in accordance with the present invention are thus useful for receiving broadcast programs from the cable television station.

What is claimed is:

1. A video receiving system comprising one main-contract video receiver and at least one sub-contract video receiver connected to the main-contract video receiver via a network,
the sub-contract video receiver comprising:
a network connection detecting unit which detects a status of connection with the main-contract video receiver in the network;
a video reception tuner unit which receives a video signal;
a video reception control unit which, when the video reception tuner unit receives the video signal, allows the video reception tuner unit to receive the video signal of a limited predetermined channel if the network connection detecting unit detects an unestablished connection with the main-contract video receiver; and
a display signal output unit which outputs a display signal corresponding to the video signal received by the video reception tuner unit.

2. The video receiving system according to claim 1, wherein the main-contract video receiver comprises:
a first identification information holding unit which pre-holds unique first identification information; and
a first identification information transmitting unit which transmits the first identification information in response to a request for transmission of the first identification information received from the sub-contract video receiver via the network, and
the sub-contract video receiver comprises:
a second identification information holding unit which pre-holds unique second identification information having the same value as that of the first identification information;
an identification information requesting unit which, when the network connection detecting unit detects an established connection with the main-contract video receiver, transmits the request for transmission of the first identification information to the main-contract video receiver; and
an identification information receiving unit which receives the first identification information transmitted by the main-contract video receiver,
wherein even when the network connection detecting unit has detected the established connection with the main-contract video receiver, the video reception control unit allows the video reception tuner unit to receive the video signal of the limited predetermined channel if the first identification information received from the main-contract video receiver does not match the second identification information pre-held by the second identification information holding unit.

3. The video receiving system according to claim 1, wherein the main-contract video receiver comprises:
a first identification information holding unit which pre-holds unique first identification information; and
a determination information transmitting unit which transmits, to the sub-contract video receiver, determination information indicating whether or not the second identification information received from the sub-contract video receiver via the network matches the first identification information pre-held by the first identification information holding unit, and
the sub-contract video receiver comprises:
a second identification information holding unit which pre-holds unique second identification information having the same value as that of the first identification information;
a second identification information transmitting unit which, when the network connection detecting unit detects an established connection with the main-contract video receiver, transmits the second identification information to the main-contract video receiver; and
a determination information receiving unit which receives the determination information transmitted by the main-contract video receiver,
wherein even when the network connection detecting unit has detected the established connection with the main-contract video receiver, the video reception control unit allows the video reception tuner unit to receive the video signal of the limited predetermined channel if the determination information received from the main-contract video receiver indicates that the second identification information does not match the first identification information.

4. The video receiving system according to claim 1, wherein the main-contract video receiver and the sub-contract video receiver have the same configuration, the main-contract video receiver has a function of the sub-contract video receiver, and the sub-contract video receiver has a function of the main-contract video receiver.

5. The video receiving system according to claim 1, wherein the network utilizes wiring which is connected to the main-contract video receiver and the sub-contract video receiver to distribute the video signal.

6. A sub-contract video receiver connected to a main-contract video receiver via a network, comprising:
a network connection detecting unit which detects a status of connection with the main-contract video receiver in the network;
a video reception tuner unit which receives a video signal;
a video reception control unit which, when the video reception tuner unit receives the video signal, allows the video reception tuner unit to receive the video signal of a limited predetermined channel if the network connection detecting unit detects an unestablished connection with the main-contract video receiver; and
a display signal output unit which outputs a display signal corresponding to the video signal received by the video reception tuner unit.

7. The sub-contract video receiver according to claim 6, further comprising:
a second identification information holding unit which pre-holds unique second identification information having the same value as that of the unique first identification information pre-held by the main-contract video receiver;
an identification information requesting unit which, when the network connection detecting unit detects an established connection with the main-contract video receiver, transmits a request for transmission of the first identification information to the main-contract video receiver; and
an identification information receiving unit which receives the first identification information transmitted by the main-contract video receiver,
wherein even when the network connection detecting unit has detected the established connection with the main-contract video receiver, the video reception control unit allows the video reception tuner unit to receive the video signal of the limited predetermined channel if the first identification information received from the main-contract video receiver does not match the second identification information pre-held by the second identification information holding unit.

8. The sub-contract video receiver according to claim 6, further comprising:
a second identification information holding unit which pre-holds unique second identification information having the same value as that of the unique first identification information pre-held by the main-contract video receiver;
a second identification information transmitting unit which, when the network connection detecting unit detects an established connection with the main-contract video receiver, transmits the second identification information to the main-contract video receiver; and
a determination information receiving unit which receives determination information transmitted by the main-contract video receiver as a result of determination of whether or not the received second identification information matches the pre-held first identification information,
wherein even when the network connection detecting unit has detected the established connection with the main-contract video receiver, the video reception control unit allows the video reception tuner unit to receive the video signal of the limited predetermined channel if the determination information indicates that the second identification information does not match the first identification information.

9. The sub-contract video receiver according to claim 6, wherein the video signal received by the video reception tuner unit is encrypted, and
the video reception tuner unit has a video decoding unit which decodes the video signal into a video.

10. The sub-contract video receiver according to claim 6, further comprising a power supply status detecting unit which detects an on/off status of a power supply for the sub-contract video receiver,
wherein the video reception control unit allows the power supply status detecting unit to detect the on status of the power supply when the video reception tuner unit receives the video signal, and allows the video reception tuner unit to receive the video signal of the limited predetermined channel if the network connection detecting unit detects the unestablished connection with the main-contract video receiver.

11. The sub-contract video receiver according to claim 6, wherein a video displayed on the basis of the video signal of the limited predetermined channel is a warning video urging normal use.

12. A main-contract video receiver connected to a sub-contract video receiver via a network, the main-contract video receiver comprising:
a first identification information holding unit which pre-holds unique first identification information; and
a first identification information transmitting unit which transmits the first identification information in response to a request for transmission of the first identification information received from the sub-contract video receiver via the network,
the sub-contract video receiver comprising:
a network connection detecting unit which detects a status of connection with the main-contract video receiver in the network;
a video reception tuner unit which receives a video signal;
a video reception control unit which, when the video reception tuner unit receives the video signal, allows the video reception tuner unit to receive the video signal of a limited predetermined channel if the network connection detecting unit detects an unestablished connection with the main-contract video receiver;
a display signal output unit which outputs a display signal corresponding to the video signal received by the video reception tuner unit;
a second identification information holding unit which pre-holds unique second identification information having the same value as that of the first identification information;
an identification information requesting unit which, when the network connection detecting unit detects an established connection with the main-contract video receiver, transmits the request for transmission of the first identification information to the main-contract video receiver; and
an identification information receiving unit which receives the first identification information transmitted by the main-contract video receiver,
wherein even when the network connection detecting unit has detected the established connection with the main-contract video receiver, the video reception control unit of the sub-contract video receiver allows the video reception tuner unit to receive the video signal of the limited predetermined channel if the first identification information received from the main-contract video receiver does not match the second identification information pre-held by the second identification information holding unit.

13. A main-contract video receiver connected to a sub-contract video receiver via a network, the main-contract video receiver comprising:
a first identification information holding unit which pre-holds unique first identification information; and
a determination information transmitting unit which transmits, to the sub-contract video receiver, determination information indicating whether or not the second identification information received from the sub-contract video receiver via the network matches the first identification information pre-held by the first identification information holding unit,
the sub-contract video receiver comprising:
a network connection detecting unit which detects a status of connection with the main-contract video receiver in the network;
a video reception tuner unit which receives a video signal;
a video reception control unit which, when the video reception tuner unit receives the video signal, allows the video reception tuner unit to receive the video signal of a limited predetermined channel if the network connection detecting unit detects an unestablished connection with the main-contract video receiver;
a display signal output unit which outputs a display signal corresponding to the video signal received by the video reception tuner unit;
a second identification information holding unit which pre-holds unique second identification information having the same value as that of the first identification information;
a second identification information transmitting unit which, when the network connection detecting unit detects an established connection with the main-contract video receiver, transmits the second identification information to the main-contract video receiver; and
a determination information receiving unit which receives the determination information transmitted by the main-contract video receiver,
wherein even when the network connection detecting unit has detected the established connection with the main-contract video receiver, the video reception control unit of the sub-contract video receiver allows the video reception tuner unit to receive the video signal of the limited predetermined channel if the determination information received from the main-contract video receiver indicates that the second identification information does not match the first identification information.

14. A video receiving method utilizing one main-contract video receiver and at least one sub-contract video receiver which connects the main-contract video receiver to a network, the method comprising:
a network connection detecting step of allowing the sub-contract video receiver to check whether or not the sub-contract video receiver is connected to the main-contract video receiver via the network;
a sub-contract receiving step of, when the sub-contract video receiver receives the video signal, allowing the sub-contract video receiver to receive the video signal of a limited predetermined channel if the sub-contract video receiver has not been connected to the main-contract video receiver yet; and
a sub-contract output step of allowing the sub-contract video receiver to output a display signal corresponding to the video signal of the limited predetermined channel.

15. A program recorded in a computer readable recording medium, the program allowing a computer to act as the video reception control unit of the sub-contract video receiver according to claim 6 which allows the video reception tuner unit to receive a video signal of a limited predetermined channel if the network connection detecting unit detects an unestablished connection with the main-contract video receiver.

16. A program recorded in a computer readable recording medium, the program allowing a computer to act as the first identification information holding unit which pre-holds unique first identification information and as the first identification information transmitting unit which transmits the first identification information in response to a request for transmission of the first identification information received from the sub-contract video receiver via the network, of the main-contract video receiver according to claim 12.

17. A program recorded in a computer readable recording medium, the program allowing a computer to act as the first identification information holding unit which pre-holds unique first identification information and as the determination information transmitting unit which transmits, to the sub-contract video receiver, determination information indicating whether or not the second identification information received from the sub-contract video receiver via the network matches the first identification information pre-held by the first identification information holding unit, of the main-contract video receiver according to claim 13.

18. A program recorded in a computer readable recording medium, the program allowing a computer to act as the first identification information transmitting unit which transmits the first identification information in response to a request for transmission of the first identification information from the sub-contract video receiver, as the identification information requesting unit which, when the network connection detecting unit detects an established connection with the main-contract video receiver, transmits the request for transmission of the first identification information to the main-contract video receiver, and as the video reception control unit which even when the network connection detecting unit has detected the established connection with the main-contract video receiver, allows the video reception tuner unit to receive the video signal of the limited predetermined channel if the first identification information does not match the second identification information, of the video receiving system according to claim 2.

19. A program recorded in a computer readable recording medium, the program allowing a computer to act as the determination information transmitting unit, and as the video reception control unit which, even when the network connection detecting unit has detected the established connection with the main-contract video receiver, allows the video reception tuner unit to receive the video signal of the limited predetermined channel if the determination information received from the main-contract video receiver indicates that the second identification information does not match the first identification information, of the video receiving system according to claim 3.

20. A program storage device readable by machine tangibly embodying the program according to claim 15.

21. A program storage device readable by machine tangibly embodying the program according to claim 16.

22. A program storage device readable by machine tangibly embodying the program according to claim 17.

23. A program storage device readable by machine tangibly embodying the program according to claim 18.

24. A program storage device readable by machine tangibly embodying the program according to claim 19.
